(19) United States
(12) Patent Application Publication
(10) Pub. No.: US 2013/0022325 A1
(43) Pub. Date: Jan. 24, 2013

(54) Drop Cable with Fiber Ribbon Conforming to Fiber Passage

(71) Applicant: Wayne M. Kachmar, North Bennington, VT (US)

(72) Inventor: Wayne M. Kachmar, North Bennington, VT (US)

(73) Assignee: ADC Telecommunications, Inc., Eden Prairie, MN (US)

(21) Appl. No.: 13/555,621

(22) Filed: Jul. 23, 2012

Related U.S. Application Data
(60) Provisional application No. 61/510,316, filed on Jul. 21, 2011.

(51) Int. Cl. G02B 6/44

(52) U.S. Cl. 385/114

(57) ABSTRACT

A fiber optic cable includes an outer jacket, an optical fiber ribbon, and strength members. The outer jacket has an elongated transverse cross-sectional profile that defines a major axis and a minor axis. The outer jacket also defines a central fiber passage that extends through the outer jacket along a lengthwise axis of the outer jacket. The optical fiber ribbon is positioned within the central fiber passage. The optical fiber ribbon has a flattened width that is larger than the central fiber passage. The optical fiber ribbon curves along the widthwise orientation of the optical fiber ribbon so as to conform generally to an arc defined by a circumference of the central fiber passage. The optical fiber ribbon is arranged in a helical pattern within the central fiber passage.

### CROSS-REFERENCE TO RELATED APPLICATION

The present application claims the benefit of U.S. Provisional Patent Application Ser. No. 61/510,316, filed Jul. 21, 2011, which application is hereby incorporated by reference in its entirety.

### TECHNICAL FIELD

The present disclosure relates to telecommunication cable. More particularly, the present disclosure relates to fiber optic cable for use in a communication network.

### BACKGROUND

A fiber optic cable typically includes: (1) an optical fiber; (2) a buffer layer that surrounds the optical fiber; (3) a plurality of reinforcing members loosely surrounding the buffer layer; and (4) an outer jacket. Optical fibers function to carry optical signals. A typical optical fiber includes an inner core surrounded by a cladding that is protected by a coating. The buffer layer functions to surround and protect the coated optical fibers. Reinforcing members add mechanical reinforcement to fiber optic cables to protect the internal optical fibers against stresses applied to the cables during installation and thereafter. Outer jackets also provide protection against chemical damage.

Drop cables used in fiber optic networks can be constructed having a jacket with a flat transverse profile. Such cables typically include a central buffer tube containing a plurality of optical fibers and reinforcing members such as rods made of glass reinforced epoxy embedded in the jacket on opposite sides of the buffer tube. U.S. Pat. No. 6,542,674 discloses a drop cable of a type described above.

### SUMMARY

One aspect of the present disclosure relates to a configuration for a cable that allows a ribbon of optical fibers to be effectively mounted within a relatively small fiber passage defined by the cable.

Another aspect of the present disclosure relates to a fiber optic cable including an outer jacket, an optical fiber ribbon, and strength members. The outer jacket has an elongated transverse cross-sectional profile that defines a major axis and a minor axis. The elongated transverse cross-sectional profile has a width that extends along the major axis and a thickness that extends along the minor axis. The width of the elongated transverse cross-sectional profile is longer than the thickness of the elongated transverse cross-sectional profile. The outer jacket also defines a central fiber passage that extends through the outer jacket along a lengthwise axis of the outer jacket. The central fiber passage defines a diameter. The optical fiber ribbon is positioned within the central fiber passage. The optical fiber ribbon includes a plurality of optical fibers that are bound together by a binding material. The optical fiber ribbon includes a widthwise orientation and a lengthwise orientation. The lengthwise orientation of the optical fiber ribbon extends along the lengthwise axis of the outer jacket. The optical fiber ribbon has a flattened width that is larger than the diameter of the central fiber passage. The optical fiber ribbon curves along the widthwise orientation of the optical fiber ribbon so as to conform generally to an arc defined by a circumference of the central fiber passage. The optical fiber ribbon is arranged in a helical pattern within the central fiber passage. The strength members are positioned within the outer jacket on opposite sides of the central fiber passage.

Still another aspect of the present disclosure relates to a fiber optic cable including an outer jacket and an optical fiber ribbon. The outer jacket defines a central fiber passage that extends through the outer jacket along a lengthwise axis of the outer jacket. The central fiber passage defines a diameter. The optical fiber ribbon is positioned within the central fiber passage. The optical fiber ribbon includes a plurality of optical fibers that are bound together by a binding material. The optical fiber ribbon includes a widthwise orientation and a lengthwise orientation. The lengthwise orientation of the optical fiber ribbon extends along the lengthwise axis of the outer jacket. The optical fiber ribbon has a flattened width that is larger than the diameter of the central fiber passage. The optical fiber ribbon curves along the widthwise orientation of the optical fiber ribbon so as to conform generally to an arc defined by a circumference of the central fiber passage. The optical fiber ribbon is arranged in a helical pattern within the central fiber passage.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

FIG. 1 is a partially cut-away top plan view of a fiber optic cable in accordance with the principles of the present disclosure;

FIG. 2 is a transverse cross-sectional view taken along section line 2-2 of the fiber optic cable of FIG. 1;

FIG. 3 is a perspective view of an optical fiber suitable for use in the fiber optic cable of FIGS. 1 and 2;

FIG. 4 is a transverse cross-sectional view of an optical fiber ribbon of the fiber optic cable of FIGS. 1 and 2, the optical fiber ribbon is shown in a laid-flat orientation prior to the optical fiber ribbon being positioned within a passage of the fiber optic cable of FIGS. 1 and 2;

FIG. 5 is a transverse cross-sectional view of the optical fiber ribbon of FIG. 4 of the fiber optic cable of FIGS. 1 and 2 showing a curvature of the optical fiber ribbon along a widthwise orientation of the optical fiber ribbon after the optical fiber ribbon has been positioned within the passage of the fiber optic cable of FIGS. 1 and 2;

FIG. 6 is a graph that schematically illustrates a lay length/pitch and a helix angle of the optical fiber ribbon of FIGS. 4 and 5 of the fiber optic cable of FIGS. 1 and 2;

FIG. 7 is a schematic view showing a system for manufacturing the fiber optic cable of FIGS. 1 and 2;

FIG. 8 is a cut-away perspective view of the fiber optic cable of FIGS. 1 and 2;

FIG. 9 is a first enlarged portion of FIG. 8;

FIG. 10 is a second enlarged portion of FIG. 8;

FIG. 11 is a transverse cross-sectional view, similar to FIG. 2, taken along the section line 2-2 of the fiber optic cable of FIGS. 1, 2, and 8, illustrating a wrap angle of the fiber optic cable of FIGS. 1, 2, and 8 and also illustrating the optical fiber ribbon of FIGS. 4 and 5 in contact with and conforming to the passage of the fiber optic cable of FIGS. 1, 2, and 8;

FIG. 12 is a transverse cross-sectional view, similar to FIGS. 2 and 11, taken along the section line 2-2 of the fiber optic cable of FIGS. 1, 2, and 8, illustrating a clearance between the optical fiber ribbon of FIGS. 4 and 5 and the passage of the fiber optic cable of FIGS. 1, 2, and 8;

FIG. 13 is a perspective view of the optical fiber ribbon of FIGS. 4 and 5 shown extending one pitch length;

FIG. 14 is a schematic perspective view further illustrating the optical fiber ribbon of FIGS. 4, 5, and 13 shown extending one pitch length;

FIG. 15 is a transverse cross-sectional view, similar to FIGS. 2, 11, and 12, taken along the section line 2-2 of the fiber optic cable of FIGS. 1, 2, and 8, illustrating deformation of the optical fiber ribbon of FIGS. 4, 5, 13, and 14; and

FIG. 16 is a schematic perspective view further illustrating the optical fiber ribbon of FIGS. 4, 5, 13, and 14, shown extending one pitch length, and further illustrating the deformation of FIG. 15 of the optical fiber ribbon.

### DETAILED DESCRIPTION

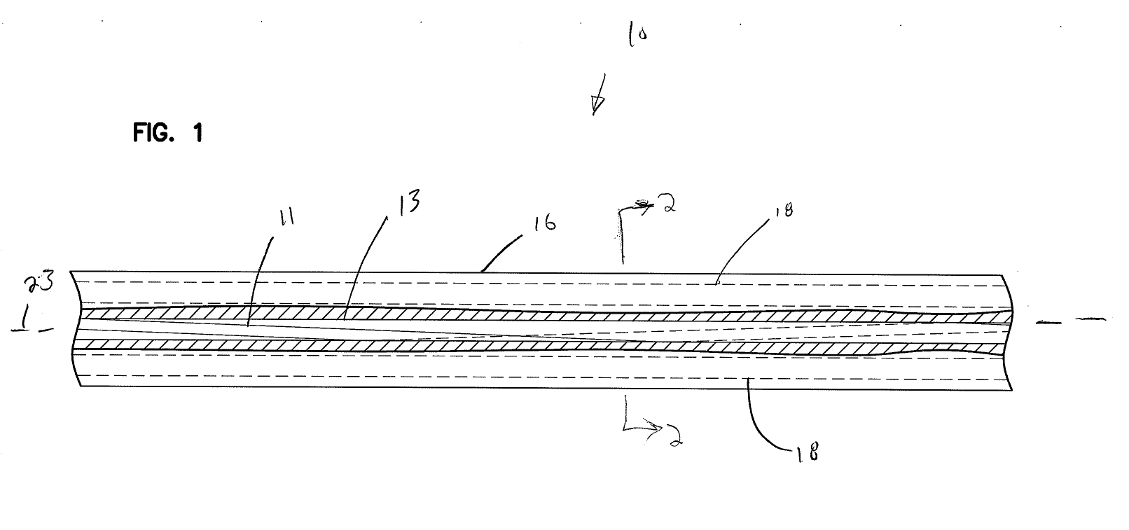

FIGS. 1, 2, and 8-12 show a fiber optic cable 10 in accordance with the principles of the present disclosure. The fiber optic cable 10 includes an optical fiber ribbon 11 including a plurality of optical fibers 12 (e.g., 12 optical fibers). The optical fiber ribbon 11 is contained within a fiber passage 13 defined by an outer jacket 16 of the fiber optic cable 10. In the depicted embodiment, the optical fiber ribbon 11 is positioned directly within the fiber passage 13 such that the optical fiber ribbon 11 contacts the outer jacket 16. In other embodiments, an intermediate buffing layer (e.g., a buffer tube) can be positioned between the optical fiber ribbon 11 and the outer jacket 16. Reinforcing members 18 are embedded in the outer jacket 16 to provide the fiber optic cable 10 with axial reinforcement (e.g., resistance to both tensile and compressive loading).

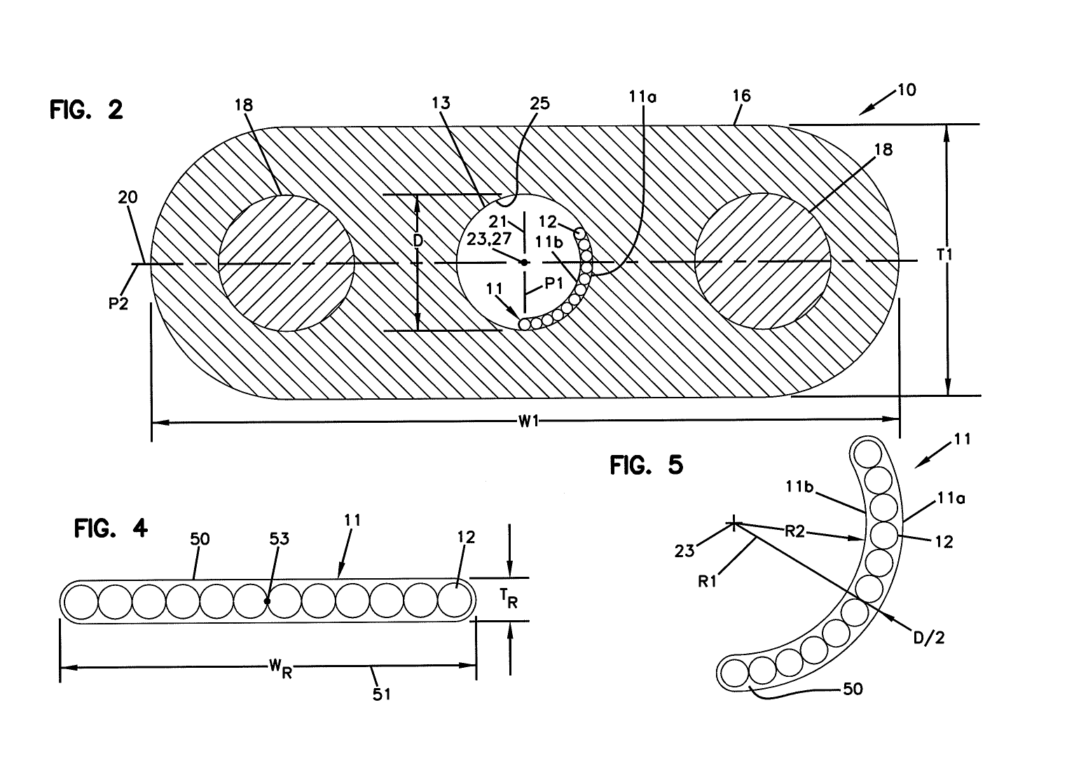

Referring to FIG. 2, the outer jacket 16 has a non-circular outer profile. For example, as shown at FIG. 2, when viewed in transverse cross-section, the outer profile of the outer jacket 16 has a flat generally obround or rectangular shape. The outer jacket 16 is longer along a major axis 20 than along a minor axis 21. The major and minor axes 20, 21 are perpendicular to one another and intersect at a center 27 of the outer jacket 16. The fiber optic cable 10 has an elongated transverse cross-sectional profile (e.g., a flattened cross-sectional profile, an oblong cross-sectional profile, an obround cross-sectional profile, etc.) defined by the outer jacket 16. A width W1 of the outer jacket 16 extends along the major axis 20 and a thickness T1 of the outer jacket 16 extends along the minor axis 21. The width W1 is longer than the thickness T1. In certain embodiments, the width W1 is at least 50 percent longer than the thickness T1. The transverse cross-sectional profile defined by the outer jacket 16 is generally rectangular with rounded ends. The major axis 20 and the minor axis 21 intersect perpendicularly at a lengthwise axis 23 of the fiber optic cable 10 which coincides with the center 27.

The construction of the fiber optic cable 10 allows the fiber optic cable 10 to be bent more easily along a plane P1 that coincides with the minor axis 21 than along a plane P2 that coincides with the major axis 20. Thus, when the fiber optic cable 10 is wrapped around a spool or guide, the fiber optic cable 10 is preferably bent along the plane P1 (i.e., the center 27 remains on the plane P1).

It will be appreciated that the outer jacket 16 of the fiber optic cable 10 can be shaped through an extrusion process and can be made by any number of different types of polymeric materials. In certain embodiments, the outer jacket 16 can have a construction that resists post-extrusion shrinkage of the outer jacket 16. For example, the outer jacket 16 can include a shrinkage reduction material disposed within a polymeric base material (e.g., polyethylene). U.S. Pat. No. 7,379,642, which is hereby incorporated by reference in its entirety, describes an exemplary use of shrinkage reduction material within the base material of a fiber optic cable jacket.

In one embodiment, the shrinkage reduction material is a liquid crystal polymer (LCP). Examples of liquid crystal polymers suitable for use in fiber-optic cables are described in U.S. Pat. Nos. 3,911,041; 4,067,852; 4,083,829; 4,130,545; 4,161,470; 4,318,842; and 4,468,364 which are hereby incorporated by reference in their entireties. To promote flexibility of the fiber optic cable 10, the concentration of the shrinkage reduction material (e.g. LCP) is relatively small as compared to the base material. In one embodiment, and by way of example only, the shrinkage reduction material constitutes less than about 10% of the total weight of the outer jacket 16. In another embodiment, and by way of example only, the shrinkage reduction material constitutes less than about 5% of the total weight of the outer jacket 16. In another embodiment, the shrinkage reduction material constitutes less than about 2% of the total weight of the outer jacket 16. In another embodiment, shrinkage reduction material constitutes less than about 1.9%, less than about 1.8%, less than 1.7%, less than about 1.6%, less than about 1.5%, less than about 1.4%, less than about 1.3%, less than about 1.2%, less than about 1.1%, or less than about 1.0% of the total weight of the outer jacket 16.

Example base materials for the outer jacket 16 include low-smoke zero halogen materials such as low-smoke zero halogen polyolefin and polycarbon. In other embodiments, the base material can include thermal plastic materials such as polyethylene, polypropylene, ethylene-propylene, copolymers, polystyrene and styrene copolymers, polyvinyl chloride, polyamide (i.e., nylon), polyesters such as polyethylene terephthalate, polyetheretherketone, polyphenylene sulfide, polyetherimide, polybutylene terephthalate, as well as other plastic materials. In still other embodiments, the outer jacket 16 can be made of low density, medium density or high density polyethylene materials. Such polyethylene materials can include low density, medium density, or high density ultra-high molecular weight polyethylene materials.

Referring still to FIG. 2, the fiber passage 13, defined by the outer jacket 16, comprises a single fiber passage that is centered within the outer jacket 16. The fiber passage 13 has a circular shape/profile when viewed in transverse cross-section. The fiber passage 13 is defined by a cylindrical inner surface 25 of the outer jacket 16 that extends through a length of the fiber optic cable 10 along the lengthwise axis 23 of the fiber optic cable 10. The circular shape of the fiber passage 13 is defined by a diameter D. In certain embodiments, the diameter D is less than 4 millimeters, or less than 3.5 millimeters, or less than or equal to 3 millimeters, or in the range of 2.5-3.5 millimeters, or in the range of 2.75-3.25 millimeters. It is preferred for the fiber passage 13 to be dry and not to be filled with a water-blocking gel. Instead, to prevent water from migrating along the fiber passage 13, structures such as water-swellable fibers, water-swellable tape, or water-swellable yarn can be provided within the fiber passage 13 along with the optical fibers 12. However, in certain embodiments water-blocking gel may be used.

Referring now to FIGS. 1, 2, 8, 11, and 12, one or more of the optical fibers 12 can be positioned within the fiber passage 13. In a preferred embodiment, the fiber passage 13 contains at least twelve of the optical fibers 12 bound together to form the optical fiber ribbon 11. The optical fibers 12 are preferably unbuffered and in certain embodiments have outer diameters D₃ in a range of 230-270 micrometers (μm).

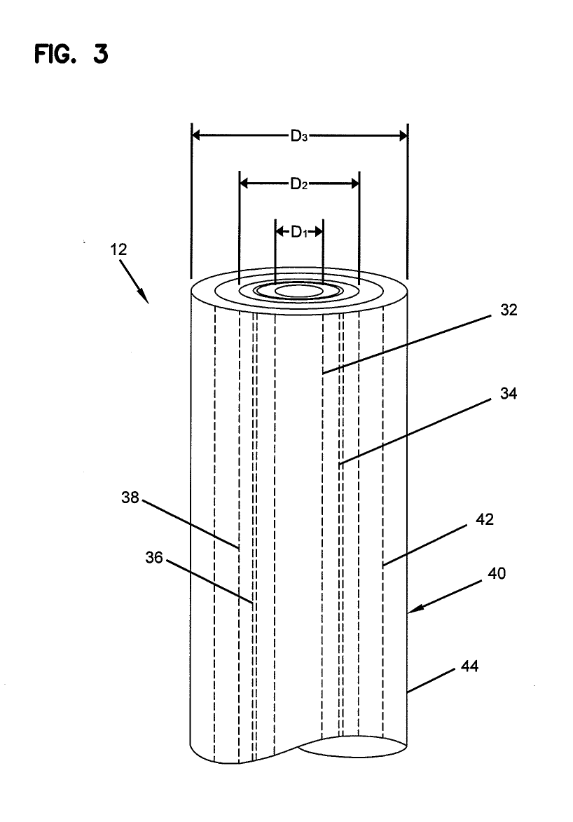

It will be appreciated that the optical fibers 12 can have any number of different types of configurations. In the embodiment of FIG. 3, the optical fiber 12 includes a core 32. The core 32 is made of a glass material, such as a silica-based material, having an index of refraction. In the subject embodiment, the core 32 has an outer diameter D₁ of less than or equal to about 10 μm.

The core 32 of each of the optical fibers 12 is surrounded by a first cladding layer 34 that is also made of a glass material, such as a silica based-material. The first cladding layer 34 has an index of refraction that is less than the index of refraction of the core 32. This difference between the index of refraction of the first cladding layer 34 and the index of refraction of the core 32 allows an optical signal that is transmitted through the optical fiber 12 to be confined to the core 32.

A trench layer 36 surrounds the first cladding layer 34. The trench layer 36 has an index of refraction that is less than the index of refraction of the first cladding layer 34. In the subject embodiment, the trench layer 36 is immediately adjacent to the first cladding layer 34.

A second cladding layer 38 surrounds the trench layer 36. The second cladding layer 38 has an index of refraction. In the subject embodiment, the index of refraction of the second cladding layer 38 is about equal to the index of refraction of the first cladding layer 34. The second cladding layer 38 is immediately adjacent to the trench layer 36. In the subject embodiment, the second cladding layer 38 has an outer diameter D₂ of less than or equal to about 125 μm.

A coating, generally designated 40, surrounds the second cladding layer 38. The coating 40 includes an inner layer 42 and an outer layer 44. In the subject embodiment, the inner layer 42 of the coating 40 is immediately adjacent to the second cladding layer 38 such that the inner layer 42 surrounds the second cladding layer 38. The inner layer 42 is a polymeric material (e.g., polyvinyl chloride, polyethylenes, polyurethanes, polypropylenes, polyvinylidene fluorides, ethylene vinyl acetate, nylon, polyester, or other materials) having a low modulus of elasticity. The low modulus of elasticity of the inner layer 42 functions to protect the optical fiber 12 from microbending.

The outer layer 44 of the coating 40 is a polymeric material having a higher modulus of elasticity than the inner layer 42. In the subject embodiment, the outer layer 44 of the coating 40 is immediately adjacent to the inner layer 42 such that the outer layer 44 surrounds the inner layer 42. The higher modulus of elasticity of the outer layer 44 functions to mechanically protect and retain the shape of the optical fiber 12 during handling. In another embodiment, the outer layer 44 has an outer diameter D₃ of less than or equal to about 275 μm.

In the subject embodiment, the optical fibers 12 are manufactured to reduce the sensitivity of the optical fibers 12 to micro or macro-bending (hereinafter referred to as “bend-insensitive”). Exemplary bend insensitive optical fibers have been described in U.S. Pat. Nos. 7,623,747 and 7,587,111 that are hereby incorporated by reference in their entirety. An exemplary bend-insensitive optical fiber is commercially available from Draka Comteq under the name BendBright XS. In other embodiments, the optical fibers 12 need not be bend insensitive optical fibers.

Referring to FIGS. 2, 4, 5, 9, and 14, the optical fiber ribbon 11 includes a plurality of the optical fibers 12 that are mechanically bound (i.e., linked, coupled, secured, etc.) together in a row by a binding material 50 (i.e., a matrix material, a substrate material, etc.). As shown at FIG. 4, prior to being laid within the outer jacket 16, the optical fiber ribbon 11 can have a flattened configuration (i.e., a sheet-like configuration or a tape-like configuration) in which the optical fiber ribbon 11 defines a flattened width W_{R} that extends along a widthwise orientation 51 of the optical fiber ribbon 11 and a length that extends along a lengthwise orientation 53 of the optical fiber ribbon 11. The width W_{R} is preferably larger than the diameter D of the fiber passage 13. In one example embodiment, the binding material 50 has a flexible composition that allows the optical fiber ribbon 11 to curve (i.e., to flex or bend) along the widthwise orientation 51 so as to conform to a curvature of the fiber passage 13. In this way, the optical fiber ribbon 11 lines a portion of the fiber passage 13 (e.g., the cylindrical inner surface 25) with the width W_{R} of the optical fiber ribbon 11 extending along an arc partially about a circumference of the fiber passage 13. An outer side 11a of the optical fiber ribbon 11 engages the cylindrical inner surface 25 of the outer jacket 16 and an inner side 11b of the optical fiber ribbon 11 faces toward the longitudinal axis 23 of the fiber optic cable 10. The outer side 11a of the optical fiber ribbon 11 extends in the widthwise direction 51 along a curvature defined by a radius R1 swung about the longitudinal axis 23 (see FIG. 5). The inner side 11b of the optical fiber ribbon 11 extends in the widthwise direction 51 along a curvature defined by a radius R2 swung about the longitudinal axis 23 (see FIG. 5). The radius R1 is equal to or approximately equal to D/2 while the radius R2 is equal to or approximately equal to the radius R1 minus a thickness T_{R} of the optical fiber ribbon 11. A neutral radius R_{N} may be defined as an average of the radii R1 and R2 (see FIG. 14).

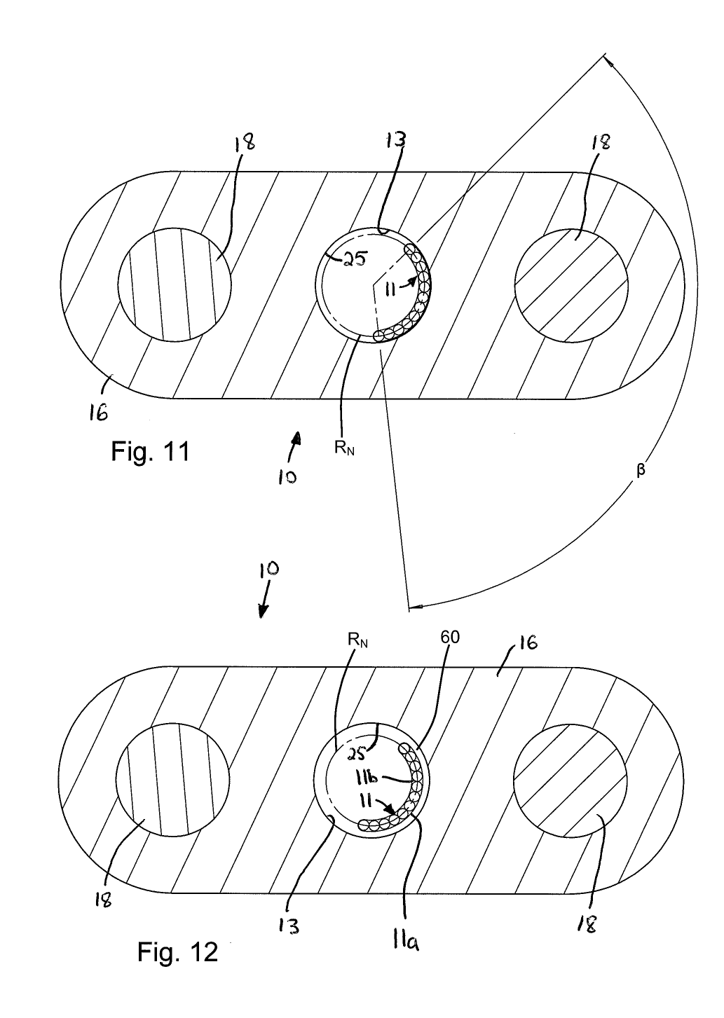

In the depicted embodiment, the flattened width W_{R} is equal to or approximately equal to the outer diameter D₃ of the optical fibers 12 times the number of optical fibers n. Thus, W_{R}≈n×D₃=12×275 μm=3,300 μm=3.3 millimeters. The binding material 50 may add slightly to the flattened width W_{R}. In the depicted embodiment, the diameter D of the fiber passage 13 is equal to or approximately equal to 3 millimeters. In the depicted embodiment, the optical fiber ribbon 11 lines a portion of the cylindrical inner surface 25 of the fiber passage 13 along an arc with an angle β of about 97 degrees (see FIG. 11). In the depicted embodiment, the thickness T_{R} of the optical fiber ribbon 11 is equal to or approximately equal to the outer diameter D₃ of the optical fiber 12. Thus, T_{R}≈D₃=275 μm. The binding material 50 may add to the thickness T_{R}. In the depicted embodiment, the radius R1 is equal to or approximately equal to the diameter D of the fiber passage 13 divided by 2. Thus, R1≈D/2=3 millimeters/2=1.5 millimeters. In the depicted embodiment, the radius R2 is equal to or approximately equal to the radius R1 minus the thickness T_{R} of the optical fiber ribbon 11. Thus, R2≈R1−T_{R}=1.5 millimeters−275 μm=1.225 millimeters. In the depicted embodiment, the radius R_{N} is equal to or approximately equal to the average of the radii R1 and R2. Thus, R_{N}≈(R1+R2)/2=(1.5 millimeters+1.225 millimeters)/2=1.3625 millimeters.

Other embodiments of the present disclosure may select other values than those selected in the preceding paragraph. For example, the outer diameter D₃ of the optical fibers 12 and the number of the optical fibers n may vary from 275 μm and 12, respectively. In an example alternative embodiment, the outer diameter D₃ of the optical fibers 12 may be 230 μm. The width W_{R} may thereby change accordingly. The diameter D of the fiber passage 13 may be varied from 3 millimeters. In the alternative embodiment, the diameter D may be 4 millimeters. In other embodiments, the angle β may vary from that shown. The angle β may vary upon selecting a different number of optical fibers n, a different diameter D of the fiber passage 13, a different outer diameter D₃ of the optical fibers 12, a different flattened width W_{R}, a different binding material 50, a different thickness T_{R} of the optical fiber ribbon 11, etc. In the alternative embodiment, the thickness T_{R} of the optical fiber ribbon 11 may be 230 μm. In the example alternative embodiment, the radius R1 is therefore equal to D/2=4 millimeters/2=2 millimeters. In the example alternative embodiment, the radius R2 is equal to R1−T_{R}=2 millimeters−230 μm=1.77 millimeters. In the example alternative embodiment, the radius R_{N} is equal to (R1+R2)/2=(2 millimeters+1.77 millimeters)/2=1.885 millimeters.

The binding material 50 can be a polymeric material such as ethylene acetate acrylate (e.g., UV-cured, etc.), silicone (e.g., RTV silicone, etc.), polyester films (e.g., biaxially oriented polyethylene terephthalate polyester film, etc.), and polyisobutylene. In other example instances, the binding material 50 may be a matrix material, an adhesive material, a finish material, or another type of material that binds, couples, and/or otherwise mechanically links together the optical fibers 12.

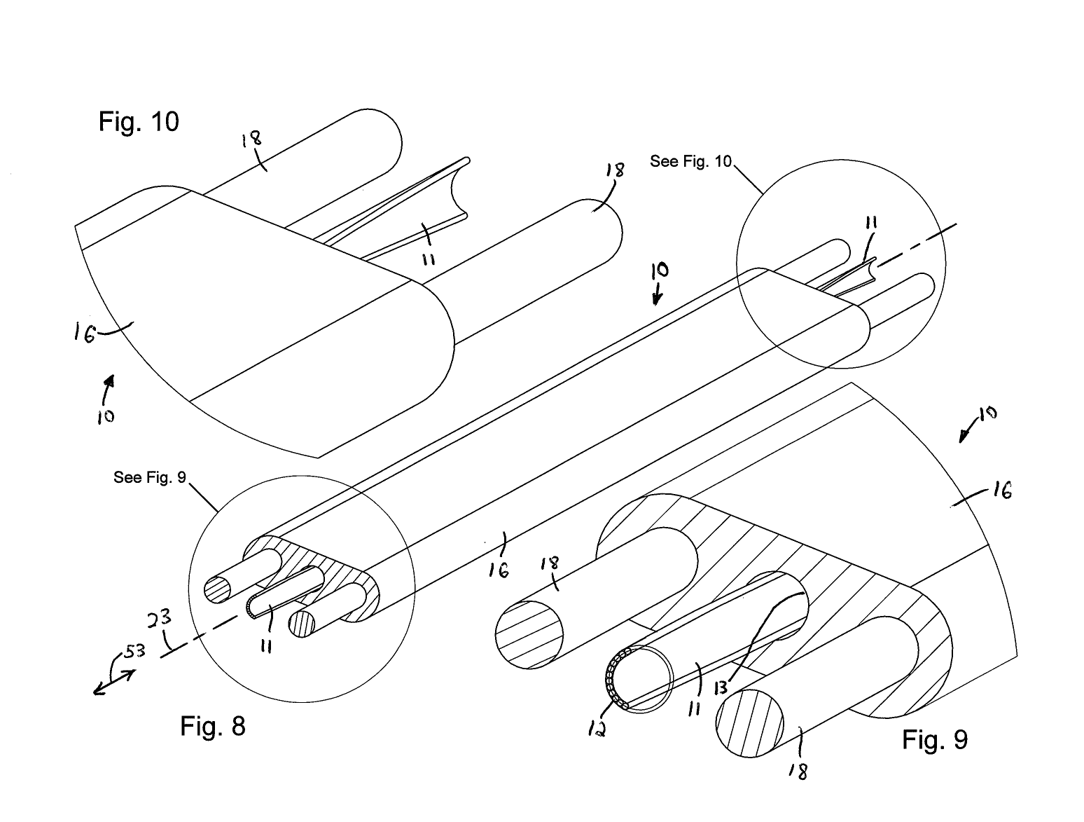

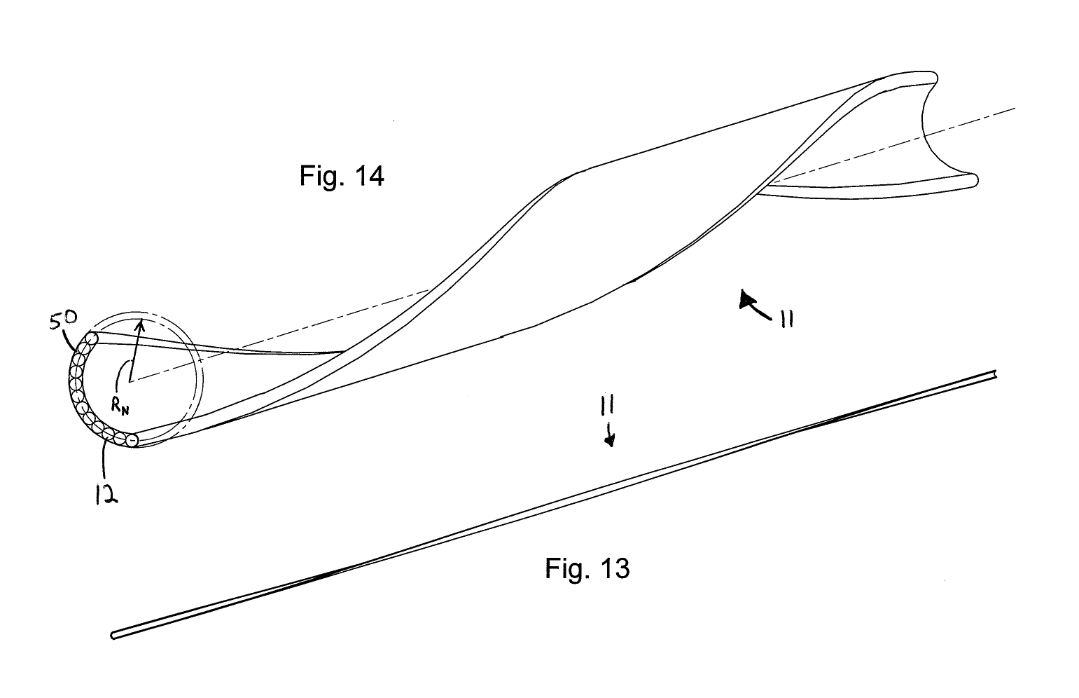

As shown at FIGS. 1 and 8-14, the optical fiber ribbon 11 lines the fiber passage 13 in a helical pattern when the fiber optic cable 10 extends along a linear path. As depicted at FIGS. 8-10, 13, and 14, the helical pattern is a left-hand helical pattern. In other embodiments, the helical pattern can be a right-hand helical pattern. In one embodiment, the optical fiber ribbon 11 has a pitch/lay length P equal to at least 0.75 meter. In other embodiments, the lay length P can be at least 1.0 meters or at least 1.2 meters. In one embodiment, the diameter D of the fiber passage 13 is in the range of about 2.5 to about 3.5 millimeters, and the lay length P is greater than 0.75 meter, or greater than 1.0 meter, or at least 1.2 meters. One unit of the lay length P is a distance measured along the longitudinal axis 23 of the fiber optic cable 10 for the optical fiber ribbon 11 to rotate one full rotation about the circumference of the fiber passage 13. As the fiber optic cable 10 extends one unit of the lay length P, the optical fiber ribbon 11 travels a circumferential distance C about the circumference of the fiber passage 13.

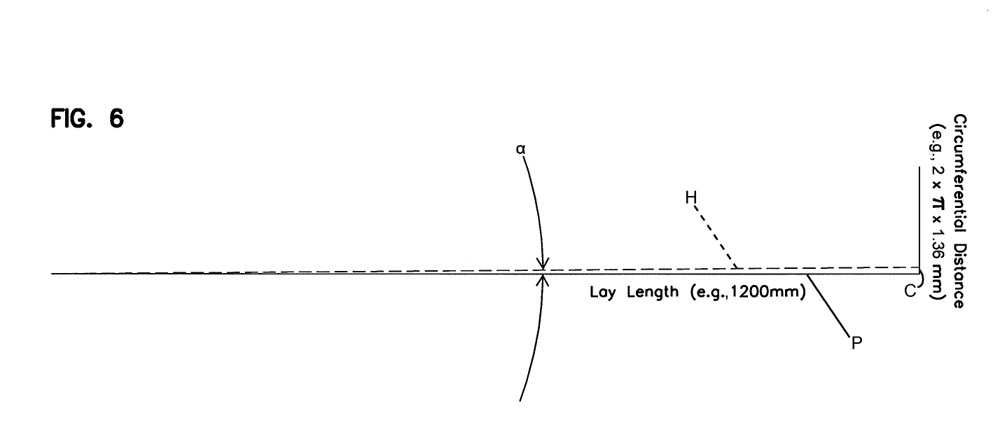

As shown at FIG. 6, the optical fiber ribbon 11 of the depicted embodiment travels the circumferential distance C of 3.14 (i.e. π) times 2 times R_{N} (e.g., 1.3625 millimeters) about the circumference of the fiber passage 13 for each unit of the lay length P (e.g., 1.2 meters). In travelling one unit of the lay length P with the fiber optic cable 10, the optical fiber ribbon 11 extends a fiber pitch length H. As illustrated at FIG. 6 and as is known in the mathematics of helixes, the fiber pitch length H=\sqrt{P²+C²}. As is known in the mathematics of helixes, each of the optical fibers 12 traveling along the helical pattern has a curvature

$$κ = \frac{\vert {R}_{N} \vert}{{R}_{N}^{2} + {( \frac{P}{2 π} )}^{2}} .$$

Also, as is known in the mathematics of helixes, each of the optical fibers 12 traveling along the helical pattern has a torsion

$$τ = \frac{( \frac{P}{2 π} )}{{R}_{N}^{2} + {( \frac{P}{2 π} )}^{2}} .$$

As illustrated at FIG. 6, an angle α is defined by the ratio of the lay length P to the circumferential distance C. In particular,

$$α = arc tan ( \frac{C}{P} ) .$$

In the depicted embodiment, the lay length P is equal to or approximately equal to 1,200 millimeters, and the neutral radius R_{N} is equal to or approximately equal to 1.3625 millimeters. Thus, the circumferential distance C≈2×π×1.3625 millimeters≈8.56 millimeters. And thus, the fiber pitch length H=\sqrt{1,200 mm²+8.56 mm²}≈1,200.03 millimeters. In the depicted embodiment, the angle

$$α = arc tan ( \frac{8.56}{1 , 200} ) \approx 0.41 degrees .$$

In the depicted embodiment

$$( \frac{P}{2 π} ) = ( \frac{1 , 200}{2 π} ) mm \approx 190.99 mm .$$

In the depicted embodiment, the curvature

$$κ = \frac{\vert 1.3625 \vert}{{1.3625}^{2} + {190.99}^{2}} = 0.0000374 / millimeters$$

As curvature relates to the reciprocal of radius, a related bend radius of the optical fibers 12 would be equal to or approximately equal to 1/κ=1/(0.0000374/millimeters)≈26,774 millimeters. In the depicted embodiment, the torsion

$$τ = \frac{190.99}{{1.3625}^{2} + {190.99}^{2}} \cdot 1 / mm = 0.0052 / millimeters .$$

In the example alternative embodiment, the lay length P may be equal to 750 millimeters. In the example alternative embodiment, the circumferential distance C is equal to 2×π×1.885 millimeters≈11.84 millimeters. In the example alternative embodiment, the fiber pitch length H=\sqrt{750 mm²+11.84 mm²}≈750.093 millimeters. In the example alternative embodiment, the angle

$$α = arc tan ( \frac{11.84}{750} ) \approx 0.904 degrees .$$

In the example alternative embodiment,

$$( \frac{P}{2 π} ) = ( \frac{750}{2 π} ) mm \approx 119.37 mm .$$

In the example alternative embodiment, the curvature

$$κ = \frac{\vert 1.885 \vert}{{1.885}^{2} + {119.37}^{2}} = 0.000132 / millimeters .$$

As curvature relates to the reciprocal of radius, a related bend radius of the optical fibers 12 would be equal to or approximately equal to 1/κ=1/(0.000132/millimeters)≈7,561 millimeters. In the example alternative embodiment, the torsion

$$τ = \frac{119.37}{{1.885}^{2} + {119.37}^{2}} \cdot 1 / mm = 0.0084 / millimeters .$$

In certain embodiments, the reinforcing members 18 can include reinforcing rods that provide the fiber optic cable 10 with both tensile and compressive reinforcement. Such rods can have a glass reinforced polymer (GRP) construction. The glass reinforced polymer can include a polymer base material (e.g., epoxy) reinforced by a plurality of glass fibers such as E-glass, S-glass or other types of glass fiber. In other embodiments, the reinforcing members 18 can have a flexible construction that provides tensile reinforcement while providing minimal resistance to compressive loading. Example reinforcing members of this type are disclosed at U.S. Patent Application Publication No. US 2010/0278493 A1, published Nov. 4, 2010, that is hereby incorporated by reference in its entirety.

As illustrated above in the depicted embodiment and the example alternative embodiment, the fiber pitch length H, measured along the optical fibers 12, is greater than the lay length P, measured along the longitudinal axis 23 of the fiber optic cable 10. When tensile loads are applied along the length of the fiber optic cable 10, the fiber optic cable 10 may stretch (e.g., elastically deform) and become longer. However, as the optical fibers 12 are coiled within the fiber optic cable 10, the optical fibers 12 do not need to stretch along their axes to accommodate the stretching of the fiber optic cable 10. Instead, the lay length P may increase to accommodate the stretching of the fiber optic cable 10. The increase of the lay length P may occur with minimal or no stretching of the optical fibers 12 along their axes. Instead, the radii R1, R2, R_{N} of the optical fiber ribbon 11 (i.e., the helical radius of the optical fibers 12) may decrease to accommodate the increase of the lay length P. Thus, fiber length initially consumed along the circumferential distance C may be transferred to the lay length P without stretching the optical fiber 12 along its axis. Thus, each fiber pitch length H may cover an increased lay length P without stretching the fiber pitch length H. The equation H=\sqrt{P²+C²}, introduced above, provides an idealized mathematical model that illustrates that the lay length P may increase as the circumferential distance C decreases while the fiber pitch length H is held constant. As the circumferential distance C decreases, the radii R1, R2, R_{N} of the optical fiber ribbon 11 (i.e., the helical radius of the optical fibers 12) decreases. As illustrated at FIG. 12, a clearance 60 may develop between the outer side 11a of the optical fiber ribbon 11 and the cylindrical inner surface 25 of the outer jacket 16 when the circumferential distance C decreases (e.g., in response to the stretching of the fiber optic cable 10). The opening of the clearance 60 does not necessarily result in axial tension being applied to the optical fibers 12. The angle β may increase in response to the circumferential distance C decreasing.

As illustrated above, the construction of the fiber optic cable 10 allows the outer jacket 16 and/or the reinforcing members 18 to be structurally decoupled from the optical fiber ribbon 11 and/or the optical fibers 12. The tensile loads, applied to the fiber optic cable 10, provide one example of utility for the structural decoupling of the optical fiber ribbon 11 and/or the optical fibers 12. Another benefit of the structural decoupling involves thermal expansion/contraction and/or differential thermal expansion/contraction. Embodiments illustrated at FIGS. 2 and 11, that are manufactured with the outer side 11a of the optical fiber ribbon 11 and the cylindrical inner surface 25 of the outer jacket 16 in contact, provide structural decoupling when the outer jacket 16 and/or the reinforcing members 18 expand relative to the optical fiber ribbon 11 and/or the optical fibers 12. Embodiments illustrated at FIGS. 2 and 11, that are manufactured with the outer side 11a of the optical fiber ribbon 11 and the cylindrical inner surface 25 of the outer jacket 16 in contact, provide structural decoupling when the optical fiber ribbon 11 and/or the optical fibers 12 contract relative to the outer jacket 16 and/or the reinforcing members 18.

In certain embodiments of the present disclosure, the clearance 60, illustrated at FIG. 12, may be built into the fiber optic cable 10. The clearance 60 allows the outer jacket 16 and/or the reinforcing members 18 to be structurally decoupled from the optical fiber ribbon 11 and/or the optical fibers 12 regardless of the differential thermal expansion/contraction that expands or contracts the outer jacket 16 and/or the reinforcing members 18 relative to the optical fiber ribbon 11 and/or the optical fibers 12.

In certain embodiments of the present disclosure, the above parameters H, P, C, α, and/or R_{N} may be selected to structurally decouple the optical fiber ribbon 11 from the outer jacket 16 over substantial differential changes in length. As discussed above, the differential changes in length can be unidirectional or bidirectional. The table below illustrates an example embodiment with a nominal fiber pitch length H of 51 millimeters and a nominal lay length P of 50 millimeters. This results in a nominal circumferential distance C of ≈10.05 millimeters, a nominal angle α of ≈11.36 degrees, a nominal neutral radius R_{N} of ≈1.60 millimeters, a nominal curvature κ of ≈0.0243/millimeters, and a bend related to the bend radius of the optical fibers 12 of ≈41.2 millimeters.

| Relative | H | P | C | α | R_{N} | κ | Bend |
|---|---|---|---|---|---|---|---|
| Length | (mm) | (mm) | (mm) | (deg.) | (mm) | (1/mm) | (mm) |
| 101.0% | 51.0 | 50.5 | 7.12 | 8.03 | 1.13 | 0.0172 | 58.1 |
| 100.8% | 51.0 | 50.4 | 7.80 | 8.80 | 1.24 | 0.0188 | 53.1 |
| 100.6% | 51.0 | 50.3 | 8.42 | 9.50 | 1.34 | 0.0203 | 49.2 |
| 100.4% | 51.0 | 50.2 | 9.00 | 10.16 | 1.43 | 0.0217 | 46.0 |
| 100.2% | 51.0 | 50.1 | 9.54 | 10.78 | 1.52 | 0.0230 | 43.4 |
| 100.0% | 51.0 | 50.0 | 10.05 | 11.36 | 1.60 | 0.0243 | 41.2 |
| 99.8% | 51.0 | 49.9 | 10.54 | 11.92 | 1.68 | 0.0254 | 39.3 |
| 99.6% | 51.0 | 49.8 | 11.00 | 12.45 | 1.75 | 0.0266 | 37.6 |
| 99.4% | 51.0 | 49.7 | 11.44 | 12.96 | 1.82 | 0.0276 | 36.2 |
| 99.2% | 51.0 | 49.6 | 11.87 | 13.46 | 1.89 | 0.0287 | 34.9 |
| 99.0% | 51.0 | 49.5 | 12.28 | 13.93 | 1.95 | 0.0297 | 33.7 |

In preferred embodiments, the parameters H, P, C, α, and/or R_{N} are chosen so as to keep the bend radius of the optical fibers 12 within allowable limits over a working range of the fiber optic cable 10. In preferred embodiments, the parameters H, P, C, α, and/or R_{N} are chosen so as to keep the torsion τ of the optical fibers 12 within allowable limits over the working range of the fiber optic cable 10. The working range of the fiber optic cable 10 includes tension, compression, bending, torsion, swelling, thermal expansion, etc. that may strain and/or stress the fiber optic cable 10 when the fiber optic cable 10 is used, stored, deployed, etc. In preferred embodiments, the parameters H, P, C, α, and/or R_{N} are chosen so as to keep the angle β (see FIG. 11) less than about 350 degrees over the working range of the fiber optic cable 10. In other words, sides of the optical fiber ribbon 11 do not overlap themselves in preferred embodiments of the present disclosure.

Referring again to the above table, the relative length from nominal between the outer jacket 16 (with or without the reinforcing members 18) and the optical fiber ribbon 11 varies about ±one percent along the longitudinal axis 23 of the fiber optic cable 10. Within this ±one percent range, the parameters H, P, C, α, and R_{N} vary as shown. Based on ranges such as those illustrated the diameter D may be chosen. Based on ranges such as those illustrated the clearance 60, if any, may be chosen.

In other embodiments, the parameters H, P, C, α, and/or R_{N} may be selected with values different than those illustrated above. In other embodiments, the parameters H, P, C, α, and/or R_{N} may be selected with values ranging between the values discussed in the present disclosure.

In the depicted embodiments of FIGS. 2 and 8-14, the outer side 11a and the inner side 11b of the optical fiber ribbon 11 are ruled surfaces (e.g. when the fiber optic cable 10 is extended straight). In the depicted embodiments of FIGS. 2 and 8-14, the outer side 11a and the inner side 11b of the optical fiber ribbon 11 are developable surfaces (i.e. have zero Gaussian curvature) when the fiber optic cable 10 is extended straight. In the depicted embodiments of FIGS. 2 and 8-14, the outer side 11a and the inner side 11b of the optical fiber ribbon 11 define portions of cylindrical surfaces when the fiber optic cable 10 is extended straight. It will be appreciated that differences in the material properties of the optical fibers 12 and the binding material 50 may result in deviations from the idealized shape of the outer side 11a and/or the inner side 11b of the optical fiber ribbon 11. It will be appreciated that imperfections, irregularities, etc., of the optical fibers 12 and/or the binding material 50 may result in deviations from the idealized shape of the outer side 11a and/or the inner side 11b of the optical fiber ribbon 11. It will be appreciated that other influences on the optical fibers 12 and/or the binding material 50 (e.g., gravity, thermal stress, vibration, etc.) may result in deviations from the idealized shape of the outer side 11a and/or the inner side 11b of the optical fiber ribbon 11.

In the depicted embodiments of FIGS. 2 and 8-14, the optical fibers 12 share the same shape, size, and length with each other when the fiber optic cable 10 is extended straight.

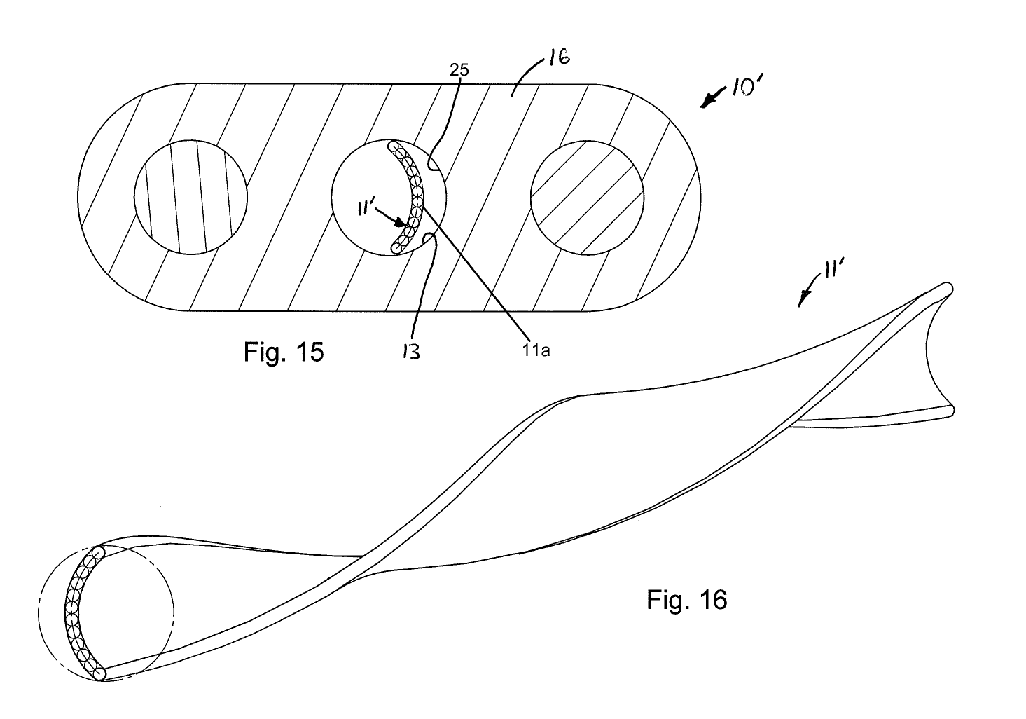

FIGS. 15 and 16 illustrate a fiber optic cable 10′ including an optical fiber ribbon 11′ that is deformed. Such deformation may occur when the fiber optic cable 10′ is manufactured with the outer side 11a of the optical fiber ribbon 11′ and the cylindrical inner surface 25 of the outer jacket 16 in contact followed by differential thermal expansion/contraction that expands the optical fiber ribbon 11′ relative to the outer jacket 16 and/or contracts the outer jacket 16 relative to the optical fiber ribbon 11′.

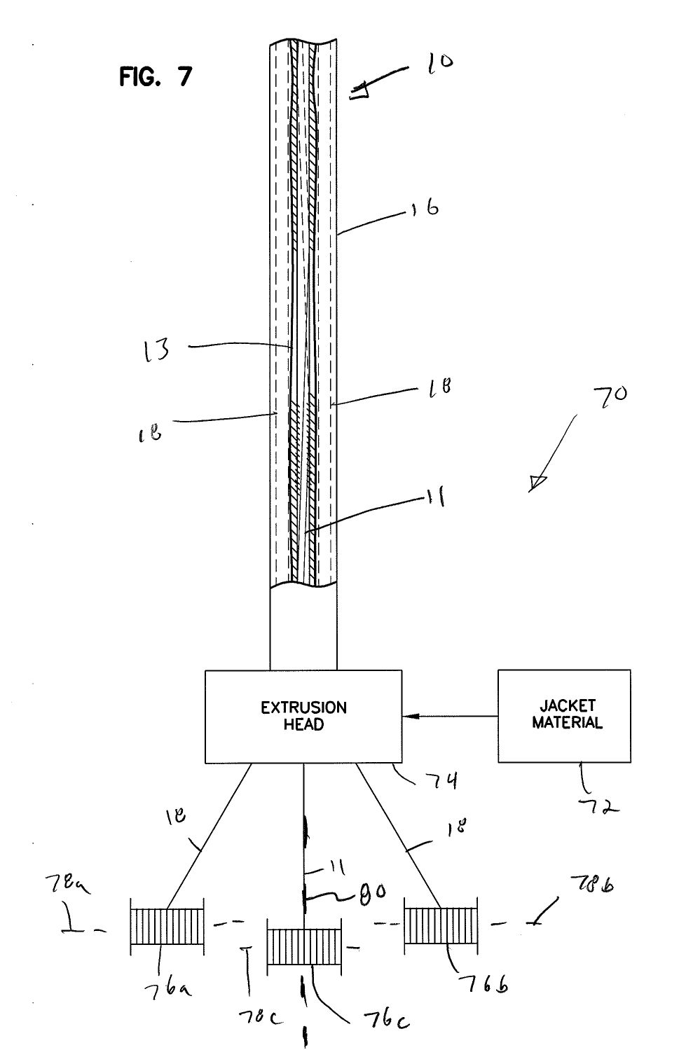

FIG. 7 shows a system 70 for manufacturing the fiber optic cable 10. The system 70 includes a jacket material source 72 at which the material used to form the outer jacket 16 of the fiber optic cable 10 is heated and masticated. The heated jacket material is pressurized and forced to flow (e.g., via an auger arrangement) through an extrusion head 74 where the material is shaped to the desired transverse cross-sectional profile of the outer jacket 16. In some embodiments, the outer jacket 16 is extruded to size while in other embodiments the outer jacket 16 is extruded to a larger size and subsequently drawn down to the desired size. As the jacket material is extruded through the extrusion head 74, the reinforcing members 18 are fed into passages formed in the jacket material during the extrusion process. Also, the optical fiber ribbon 11 is fed into the central fiber passage 13 which is also formed in the jacket material during the extrusion process. The optical fiber ribbon 11, as well as the reinforcing members 18, are paid-off from spools 76a, 76b, and 76c. The spools 76a, 76b, and 76c rotate about central axes of rotation 78a, 78b, and 78c, respectively, to allow the reinforcing members 18 and the optical fiber ribbon 11 to be paid-off from the spools 76a, 76b, 76c as the outer jacket 16 is extruded through the extrusion head 74. The spool 76c is also rotated about an axis 80 that is perpendicular to the axis 78c. By rotating the spool 76c about the axis 80 during the extrusion process, the optical fiber ribbon 11 is twisted in a helix as the optical fiber ribbon 11 is fed into the fiber passage 13. The spool 76c can be rotated about the axis 80 at a rate of one rotation per unit of cable lay length extruded from the extrusion head 74.

The above specification provides examples of how certain inventive aspects may be put into practice. It will be appreciated that the inventive aspects can be practiced in other ways than those specifically shown and described herein without departing from the spirit and scope of the inventive aspects of the present disclosure.

1. A fiber optic cable comprising:
an outer jacket having an elongated transverse cross-sectional profile defining a major axis and a minor axis, the elongated transverse cross-sectional profile having a width that extends along the major axis and a thickness that extends along the minor axis, the width of the elongated transverse cross-sectional profile being longer than the thickness of the elongated transverse cross-sectional profile, the outer jacket also defining a central fiber passage that extends through the outer jacket along a lengthwise axis of the outer jacket, the central fiber passage defining a diameter;
an optical fiber ribbon positioned within the central fiber passage, the optical fiber ribbon including a plurality of optical fibers bound together by a binding material, the optical fiber ribbon including a widthwise orientation and a lengthwise orientation, the lengthwise orientation of the optical fiber ribbon extending along the lengthwise axis of the outer jacket, the optical fiber ribbon having a flattened width that is larger than the diameter of the central fiber passage, the optical fiber ribbon curving along the widthwise orientation of the optical fiber ribbon so as to conform generally to an arc defined by a circumference of the central fiber passage, the optical fiber ribbon being arranged in a helical pattern within the central fiber passage; and
strength members positioned within the outer jacket on opposite sides of the central fiber passage.

2. The fiber optic cable of claim 1, wherein the central fiber passage has a generally round transverse cross-sectional profile.

3. The fiber optic cable of claim 1, wherein the plurality of the optical fibers includes bend insensitive optical fibers.

4. A fiber optic cable comprising:
an outer jacket defining a central fiber passage that extends through the outer jacket along a lengthwise axis of the outer jacket, the central fiber passage defining a diameter; and
an optical fiber ribbon positioned within the central fiber passage, the optical fiber ribbon including a plurality of optical fibers bound together by a binding material, the optical fiber ribbon including a widthwise orientation and a lengthwise orientation, the lengthwise orientation of the optical fiber ribbon extending along the lengthwise axis of the outer jacket, the optical fiber ribbon having a flattened width that is larger than the diameter of the central fiber passage, the optical fiber ribbon curving along the widthwise orientation of the optical fiber ribbon so as to conform generally to an arc defined by a circumference of the central fiber passage, the optical fiber ribbon being arranged in a helical pattern within the central fiber passage.
